(19) United States
(12) Patent Application Publication
(10) Pub. No.: US 2007/0145204 A1
(43) Pub. Date: Jun. 28, 2007

(54) Movable arm and design method of movable arm

(75) Inventor: Hiroshi Miyasaki, Tsubame (JP)

Correspondence Address: BACON & THOMAS, PLLC, 625 SLATERS LANE, FOURTH FLOOR, ALEXANDRIA, VA, 22314, US

(73) Assignee: Matsushita Electric Works, Ltd.,, Osaka (JP)

(21) Appl. No.: 11/589,837

(22) Filed: Oct. 31, 2006

(30) Foreign Application Priority Data
Dec. 22, 2005 (JP) 2005-371020

(51) Int. Cl. F16M 11/00

(52) U.S. Cl. 248/162.1

(57) ABSTRACT

A movable arm includes a base secured to a mounting surface; a movable body pivotally attached to the base to rotate about the base and carrying an object; and a restoring body for biasing the movable body to a home position. An elastic modulus of the restoring body, a deformation amount of the restoring body in the home position and dimensions of individual parts are determined to ensure that the gravity acting on the movable body and the biasing force exerted by the restoring body are balanced regardless of the position of the movable body. Therefore, the position of the movable body can be maintained by the elastic force of the restoring body regardless of the frictional force and thus the movable arm is hardly affected by the wear, attaining a greater life span than in a case of maintaining the movable body by the frictional force.

### FIELD OF THE INVENTION

The present invention relates to a movable arm for supporting an object such as a lighting fixture or the like and a method of designing the same.

### BACKGROUND OF THE INVENTION

Conventionally, use has been made of a movable arm that includes a base fixedly secured to a mounting surface and a movable body having one end portion pivotally attached to the base and an opposite end portion to which an object to be supported is attached. The movable arm is adapted to support the object, e.g., a lighting fixture or a camera, such that the object can be freely movable with respect to the mounting surface.

In the conventional movable arm, the position of the movable body relative to the base is maintained by the frictional force acting between the movable body and the base (see, e.g., Japanese Patent Publication No. H6-42323)

Moreover, since contact parts between the movable body and the base are worn each time the movable body is displaced with respect to the base. Therefore, sooner or later, no frictional force acts between the movable body and the base, which makes it impossible for the movable body to be kept at a fixed position; or the movable body may be caused to extend awry and is caught against movement, which makes it difficult for the user to rotate the movable body, resulting in shortened life span of the movable arm.

### SUMMARY OF THE INVENTION

It is, therefore, an object of the present invention to provide a movable arm that the life span is extended and a method of designing the same.

In accordance with a first aspect of the invention, there is provided a movable arm including:

a base mounted on a mounting surface;

a movable body for supporting an object, the movable body being pivotally attached to the base to rotate to change a position of the object with respect to the base; and

a restoring body for biasing the movable body in a direction to return the movable body to a home position with respect to the base, the restoring body being coupled to the movable body at a first coupling location spaced apart from a pivot axis of the movable body and to the base at a second coupling location spaced apart from the pivot axis of the movable body, the restoring body exerting a elastic force in a direction to make the first and second coupling location move closer to or away from each other,

wherein a elastic modulus of the restoring body, a deformation amount of the restoring body in the home position and dimensions related to the base, the movable body and the restoring body are determined to allow that

when the base is mounted on the mounting surface such that the second coupling location of the restoring body to the base and the pivot axis of the movable body lie on a common vertical plane and a center of gravity of the movable body and the object as a whole is placed above the pivot axis of the movable body while the movable body is in the home position,

a force exerted by a gravity to increase displacement of the movable body away from the home position is balanced with a force exerted by the restoring body to return the movable body to the home position, regardless of a position of the movable body with respect to the base, at least between the home position and a position in which the pivot axis of the movable body and the center of gravity of the movable body and the object as a whole lie side by side in a horizontal direction.

In accordance with the first aspect of the present invention, the position of the movable body relative to the base is maintained by the elastic force of the restoring body regardless of the frictional force. This makes it possible to eliminate or to reduce the influence of wear, causing the movable arm to exhibit a greater life span than in the case where the position of the movable body is maintained by the frictional force.

Preferably, the movable arm may further include a sliding body being interposed between the base and the movable body, the sliding body made of a material having a smaller friction coefficient than the base and the movable body.

Consequently, it is possible to reduce the frictional force acting between the base and the movable body, thereby decreasing the power required for operating the movable body.

In accordance with a second aspect of the present invention, there is provided a method of designing the movable arm of the first aspect, including the step of solving an identity equation for a parameter indicative of the position of the movable body with respect to the base to determine the elastic modulus of the restoring body, the deformation amount of the restoring body in the home position and the dimensions related to the base, the movable body and the restoring body.

In accordance with the present invention, a elastic modulus of the restoring body, a deformation amount of the restoring body in the home position and dimensions of the base, the movable body and the restoring body are determined by, e.g., solving an identity equation for a parameter indicative of the position of the movable body with respect to the base, so that a force exerted by a gravity to increase displacement of the movable body away from the home position can be balanced with a force exerted by the restoring body to return the movable body to the home position, regardless of a position of the movable body with respect to the base, at least between the home position and a position in which the pivot axis of the movable body and the center of gravity of the movable body and the object as a whole lies side by side in a horizontal direction.

As a result, the position of the movable body relative to the base is maintained by the elastic force of the restoring body regardless of the frictional force. This helps to eliminate or reduce the influence of wear, making it possible for the movable arm to exhibit durability for a greater period of life span than that of the case where the position of the movable body is maintained by the frictional force.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view showing a movable arm in accordance with one embodiment of the present invention;

FIG. 2 is a perspective view illustrating a major part of the movable arm shown in FIG. 1;

FIG. 3 is an exploded perspective view depicting the major part of the movable arm shown in FIG. 1;

FIGS. 4A to 4C are explanatory views illustrating the operation of the movable arm shown in FIG. 1, wherein FIG. 4A shows a movable body kept in a home position, FIG. 4B illustrates the movable body displaced from the home position, and FIG. 4C depicts the movable body whose displacement is further increased from the state illustrated in FIG. 4B;

FIG. 5 is an explanatory view illustrating a method of calculating a condition required for imparting desired property to a movable arm;

FIG. 6 is a perspective view showing a movable arm in accordance with another embodiment of the present invention; and

FIG. 7 is a perspective view showing a movable arm in accordance with a further embodiment of the present invention.

### DETAILED DESCRIPTION OF THE PREFERRED EMBODIMENTS

Preferred embodiments of the present invention will now be described with reference to the accompanying drawings.

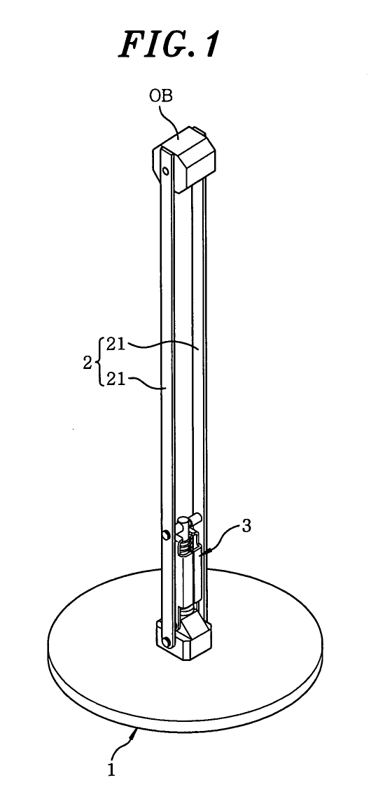

In the embodiment shown in FIG. 1, a movable arm includes a base 1 placed on a floor surface serving as a mounting surface; a movable body 2 having one end portion pivotally attached to the base 1 for rotation within a plane normal to the floor surface and the opposite end portion to which an object OB to be supported, e.g., a lighting fixture, is attached; and a restoring body 3 pivotally attached to the base 1 at a location upper than a pivot axis of the movable body 2 and also pivotally attached to the movable body 2 at a location closer to the object OB than the pivot axis of the movable body 2, the restoring body 3 rotating within the common plane on which the movable body 2 rotates. Hereinbelow, a “top-bottom direction” is defined on the basis of FIG. 1. The direction extending from the left top to the right bottom in FIG. 1 is referred to as a “left-right direction” and the direction extending from the left bottom to the right top in FIG. 1 is referred to as a “front-rear direction”.

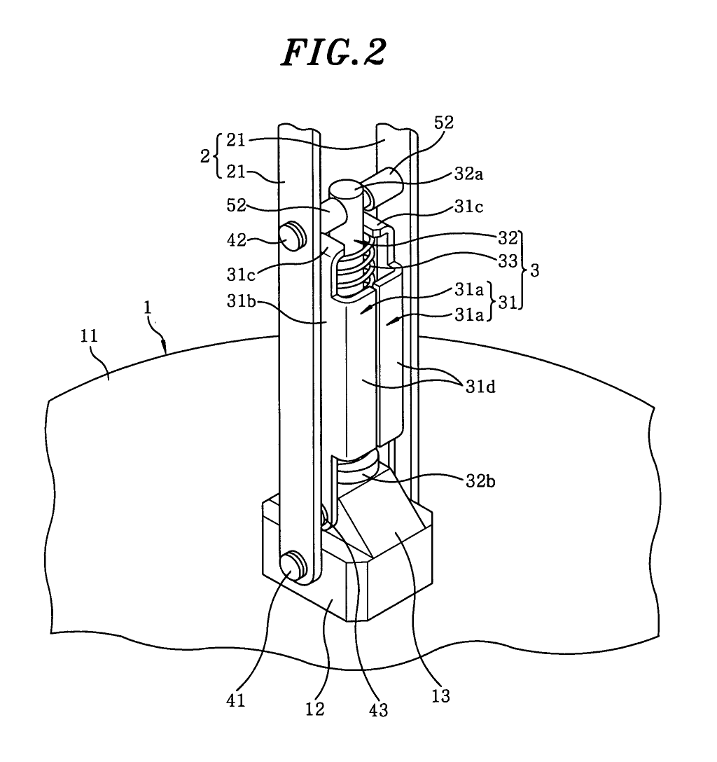

More specifically, as illustrated in FIG. 2, the base 1 includes a disk-shaped pedestal portion 11 placed on the floor surface; a movable body coupling portion 12 protruding upwardly from the center of the pedestal portion 11 and having a generally rectangular hexahedron shape, the movable body 2 being coupled to the front and rear surfaces of the movable body coupling portion 12; and a restoring body coupling portion 13 protrudingly provided on the top surface of the movable body coupling portion 12 and having a hexahedron shape, the restoring body 3 being coupled to the front and rear surfaces of the restoring body coupling portion 13. The restoring body coupling portion 13 has left and right surfaces respectively inclined in such directions as to gradually reduce the left-right dimension of the restoring body coupling portion 13 from the bottom to the top.

Furthermore, the restoring body coupling portion 13 has a front-rear dimension smaller than that of the movable body coupling portion 12, thereby leaving shoulders both between the front surfaces and between the rear surfaces of the movable body coupling portion 12 and the restoring body coupling portion 13.

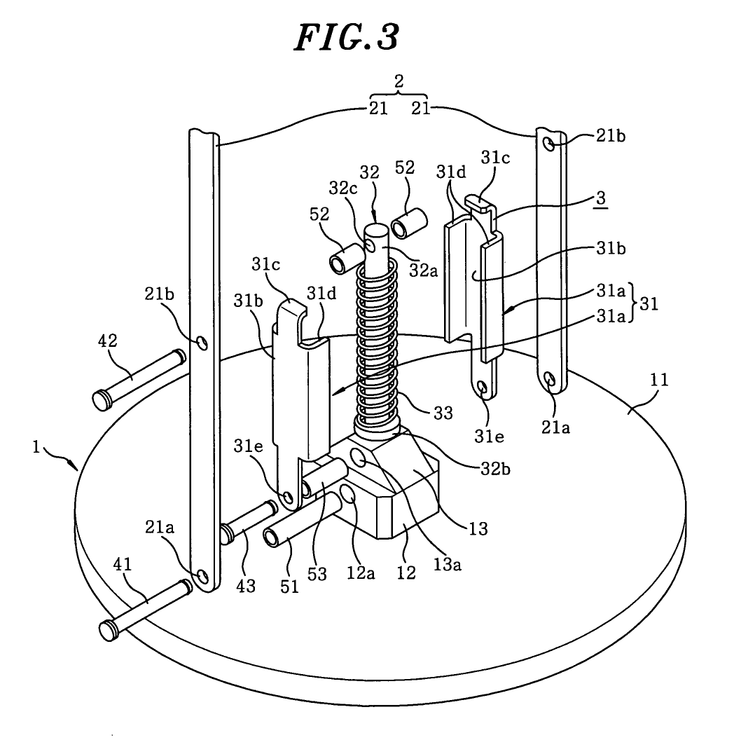

Referring to FIG. 3, the movable body 2 is formed of two elongated thin movable plates 21. The movable plates 21 are arranged such that their thickness direction lies in the front-rear direction. The movable plates 21 are coupled at one end portions thereof to the object OB in such a way that the object OB is sandwiched between the one end portions in the front-rear direction. The opposite end portions of the movable plates 21 are pivotally attached to the base 1 in such a fashion that the movable body coupling portion 12 of the base 1 is sandwiched between the opposite end portions in the front-rear direction. Each of the movable plates 21 is made of, e.g., a metal plate. First shaft insertion holes 21a and 12a are respectively formed through the opposite end portions of the movable plates 21 and the movable body coupling portion 12 of the base 1 in the thickness direction thereof. A first shaft rod 41 is inserted through the first shaft insertion holes 21a and 12a, whereby the movable body 2 is pivotally attached to the base 1 for rotation within a plane normal to the base 1 in the left-right direction.

The restoring body 3 includes a base side member 31 being pivotally attached to the base 1; a movable body side member 32 coupled at one end portion thereof to the movable body 2; and a restoring spring 33 formed of a coil spring and interposed between the base side member 31 and the movable body side member 32.

The movable body side member 32 has a cylindrical shaft portion 32a inserted through the restoring spring 33; and a disk-shaped spring seat portion 32b having an outer diameter greater than that of the shaft portion 32a, the spring seat portion 32b having one surface whose center portion is connected to one axial end portion of the shaft portion 32a, one axial end portion of the restoring spring 33 resiliently resting on the one surface of the spring seat portion 32b. Second shaft insertion holes 32c and 21b are respectively formed in the front-rear direction through the distal end portion of the shaft portion 32a away from the spring seat portion 32b and through more central portions of the movable plates 21 in the length direction thereof than the first shaft insertion holes 21a.

A second shaft rod 42 is inserted through the second shaft insertion holes 32c and 21b in such a manner that the movable body side member 32 is sandwiched between the movable plates 21 in the front-rear direction, whereby the movable body side member 32 is pivotally attached to the movable body 2 for rotation within a plane extending in the left-right direction in a parallel relationship with the movable body 2.

The base side member 31 includes two outer bodies 31a respectively made of, e.g., metal plates, and adapted to enclose the movable body side member 32 and the restoring spring 33 in the front-rear direction. Each of the outer bodies 31a has a main body portion 31b of an elongated thin plate shape whose thickness direction lies in the front-rear direction, one end portion of the main body portion 31b being coupled to the base 1; a spring seat portion 31c protruding inwardly in the front-rear direction from the opposite end of the main body portion 31b, the restoring spring 33 resiliently resting on the spring seat portion 31c at a location opposite to the spring seat portion 32b of the movable body side member 32; and enclosure portions 31d protruding inwardly in the front-rear direction from the widthwise opposite ends of the main body portion 31b to enclose the restoring spring 33 and the movable body side member 32.

The restoring spring 33 is compressively retained in an axial direction thereof between the spring seat portions 31c of the base side member 31 and the spring seat portion 32b of the movable body side member 32, thus serving as a compression spring which is normally kept compressed in the axial direction with a compressed length shorter than the free length thereof. Third shaft insertion holes 31e and 13a are formed in the front-rear direction through the distal end portions of the outer bodies 31a away from the spring seat portions 31c of the respective main body portions 31b and through the restoring body coupling portion 13 of the base 1. A third shaft rod 43 is inserted through the third shaft insertion holes 31e and 13a in the front-rear direction, whereby the base side member 31 is pivotally attached to the base 1 for rotation within the plane normal to the base 1 in the left-right direction.

As the shaft rods 41, 42 and 43 mentioned hereinabove, use is made of, e.g., bolts, each having a head portion and a male thread portion formed only at the distal axial end portion from the head portion. Removal of the bolts is prevented by thread-coupling nuts (not shown) to the male thread portions after the bolts have been inserted through the shaft insertion holes 12a, 13a, 21a, 21b, 31e and 32c.

Each of the enclosure portions 31d has a projection dimension from the main body portion 31b which is equal to about one half of the front-rear dimension of the restoring body coupling portion 13 of the base 1. Accordingly, in the state that the base side member 31 is attached to the base 1, the outer bodies 31a are arranged such that the leading end surfaces of the enclosure portions 31d are in contact with each other. The movable body side member 32 is interposed between the mutually facing enclosure portions 31d, which ensures that the movable body side member 32 is slidably guided with respect to the base side member 31 in the axial direction of the shaft portion 32a. In other words, the length direction of the base side member 31, the axial direction of the shaft portion 32a of the movable body side member 32 and the axial direction of the restoring spring 33 coincide with one another at all times regardless of the manner of rotation of the base side member 31.

Moreover, one of the opposite axial ends of the restoring spring 33, i.e., the axial end of the restoring spring 33 distant from the coupling portion of the restoring body 3 and the base 1 resiliently rests against the base side member 31, while the other of the opposite axial ends of the restoring spring 33, i.e., the axial end of the restoring spring 33 distant from the coupling portion of the restoring body 3 and the movable body 2 resiliently rests against the movable body side member 32. This makes sure that the elastic force of the restoring spring 33 functioning as a compression spring acts in such a direction as to make the coupling portions of the restoring body 3 to the base 1 and to the movable body 2 come closer, namely in such a direction as to shorten the overall length of the restoring body 3.

Moreover, the first shaft insertion hole 12a and the third shaft insertion hole 13a have their axes extending parallel to each other and are arranged one above the other. The center axis of the first shaft rod 41, i.e., the pivot axis about which the movable body 2 rotates with respect to the base 1, and the center axis of the third shaft rod 43, i.e., the pivot axis about which the restoring body 3 rotates with respect to the base 1, are placed on a same plane disposed normal to the bottom surface of the pedestal portion 11 of the base 1. Under a state that the base 1 is placed on a horizontal surface, the pivot axis about which the movable body 2 rotates with respect to the base 1 lies vertically below the pivot axis about which the restoring body 3 rotates with respect to the base 1.

In this connection, a first sliding bearing 51 of a cylindrical shape serving as a sliding body is inserted into the first shaft insertion hole 12a of the base 1 and the first shaft rod 41 is inserted through the first sliding bearing 51.

Moreover, second sliding bearings 52 of a cylindrical shape are provided on the front and rear sides of the movable body side member 32 and interposed between the shaft portion 32a of the movable body side member 32 and the respective movable plates 21. The second shaft rod 42 is inserted through the second sliding bearings 52. One axial end of each of the second sliding bearings 52 is adjacent to the movable body side member 32, while the other axial end of each of the second sliding bearings 52 is in proximity to the corresponding one of the movable plates 21. A third sliding bearing 53 of a cylindrical shape is inserted into the third shaft insertion hole 13a of the base 1 and the third shaft rod 43 is inserted through the third sliding bearing 53.

As a material of the respective sliding bearings 51, 52 and 53, use is made of a material having a friction coefficient smaller than that those of the base 1, movable body 2 and the restoring body 3. More concretely, it is possible to use a synthetic resin having a relatively low friction coefficient, such as polyethylene terephthalate (PET), polyacetal or the like. The sliding bearings 51, 52 and 53 function to reduce the frictional force acting between the base 1, the movable body 2 and the restoring body 3, thereby decreasing the operating force required at the time of rotating the movable body 2 with respect to the base 1.

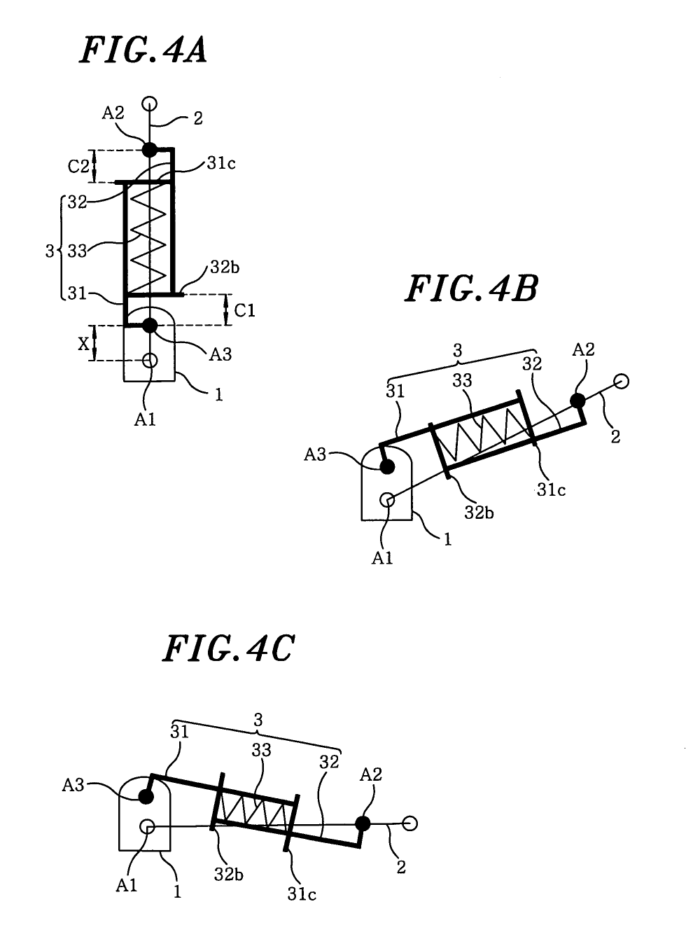

Operation of the movable arm of this embodiment in case where the base 1 is mounted on a horizontal surface will now be described with reference to FIGS. 4A through 4C diagrammatically illustrating the structure of the movable arm of this embodiment. As already set forth, the restoring body 3 has resilience that acts in such a direction as to shorten the overall length of the restoring body 3, namely in such a direction as to make come closer the pivot axis A3 of the restoring body 3 on the side of the base 1 (the center axis of the third shaft rod 43) and the pivot axis A2 of the restoring body 3 on the side of the movable body 2 (the center axis of the second shaft rod 42).

The distance between the pivot axis A1 of the movable body 2 on the side of the base 1 (the center axis of the first shaft rod 41) and the pivot axis A2 and the distance between the pivot axis A1 of the movable body 2 and the pivot axis A3 of the restoring body 3 on the side of the base 1 are substantially constant. This is because the movable body 2 and the base 1 undergo little elastic deformation. Further, the pivot axis A3 of the restoring body 3 on the side of the base 1 lies vertically above the pivot axis A1 of the movable body 2.

Thus, among the various positions possibly taken by the movable body 2 with respect to the base 1, the position in which the distance between the pivot axes A3 and A2 of the restoring body 3 on the side of the base 1 and the movable body 2 becomes smallest, i.e., the position in which the deformation amount of the restoring spring 33 is minimized, is the upright position illustrated in FIG. 4A wherein the pivot axis A2 of the restoring body 3 on the side of the movable body 2 lies vertically above the pivot axis A1 of the movable body 2 on the side of the base 1. In other words, the elastic force of the restoring body 3 acts in such a manner as to return the movable body 2 into the upright position as illustrated in FIG. 4A; and in this embodiment, the upright position shown in FIG. 4A is a home position, among the positions that can be taken by the movable body 2. Moreover, although the deformation amount of the restoring spring 33 is minimized in the home position, it can be said that the restoring spring 33 is kept compressed from its free length even in the home position.

Further in this embodiment, the movable body 2 is symmetrically shaped with respect to the plane containing the pivot axes A1 and A2 of the movable body 2 on the side of the base 1 and the restoring body 3. Moreover, the object OB to be supported has an external shape symmetrical with respect to the aforementioned plane, and the center of gravity of the object OB lies on the plane. Accordingly, the overall center of gravity of the movable body 2 and the object OB is placed vertically above the pivot axis of the movable body 2 on the side of the base 1.

If the movable body 2 is inclined from the home position illustrated in FIG. 4A into the position depicted in FIG. 4B, the distance between the pivot axes A3 and A2 of the restoring body 3 on the side of the base 1 and the movable body 2 becomes greater, and the distance between the spring seat portion 31c of the base side member 31 and the spring seat portion 32b of the movable body side member 32 becomes smaller, thereby further compressing the restoring spring 33. The deformation amount (compression amount) of the restoring spring 33 is increased in proportion to the displacement of the movable body 2 away from the home position, which in turn increases the elastic force, i.e., the restoring force, of the restoring body 3. However, as for the gravity acting on the movable body 2 and the object OB, the component of gravity received by the movable body 2 is reduced, thereby increasing the component of gravity that acts in such a direction as to incline the movable body 2.

The movable arm of this embodiment is designed to ensure that, independently of the position of the movable body 2 with respect to the base 1 (hereinafter simply referred to as “the position of the movable body 2), the force of the restoring body 3 acting to return the movable body 2 to the home position and the gravitational force acting to have the movable body 2 inclined are balanced between the home position illustrated in FIG. 4A and the position depicted in FIG. 4C where the length direction of the movable body 2 lies horizontally. Described in the following is a detail method of obtaining the condition that needs to be met to make the above balancing action come true.

Assuming the free length of the restoring spring 33 is “a” and the compression amount of the restoring spring 33 in the home position is “b”, the length of the restoring spring 33 in the home position is equal to “a−b”. Also let, when in the home position, the distance between the pivot axis A3 of the restoring body 3 on the side of the base 1 and the restoring spring 33 be “c1”; the distance between the pivot axis A2 of the restoring body 3 on the side of the movable body 2 and the restoring spring 33 be “c2”; and “c1+c2” be equal to “c”. Then, in the home position, the distance between the pivot axes A3 and A2 of the restoring body 3 on the side of the base 1 and the movable body 2 is represented by “a−b+c”, which is the sum of the length of the restoring spring 33, i.e., “a−b”, and the length of the other parts than the restoring spring 33, i.e., “c”.

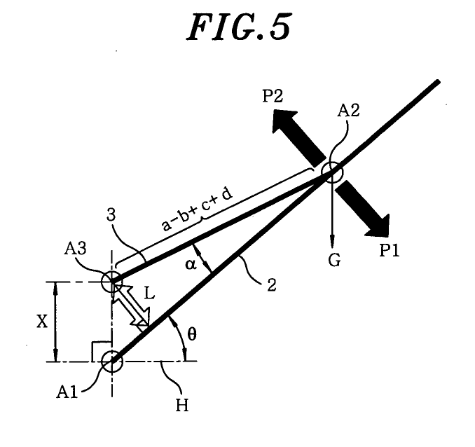

In the position illustrated in FIG. 5 where the movable body 2 is displaced from the home position to make an angle of “θ(rad)” with respect to the horizontal plane (hereinafter referred to as a “displaced position”), let the angle between the plane containing the pivot axes A3 and A2 of the restoring body 3 on the side of the base 1 and the movable body 2 and the plane containing the pivot axes A1 and A2 of the movable body 2 on the side of the base 1 and the restoring body 3 is “α(rad)”. The distance between the pivot axes A3 and A2 of the restoring body 3 on the side of the base 1 and the movable body 2 in the displaced position is to a value greater than that in the home position. Let the distance thus increased be “d”. That is, in the displaced position, the distance between the pivot axes A3 and A2 of the restoring body 3 on the side of the base 1 and the movable body 2 is represented by “a−b+c+d”. The numeric value “d” is the increment in the deformation amount of the restoring body 3, i.e., the deformation amount (compression amount) of the restoring spring 33, when the restoring body 3 is displaced from the home position to the displaced position.

The distance “L” between the plane containing the pivot axes A1 and A2 of the movable body 2 on the side of the base 1 and the restoring body 3 and the pivot axis A3 of the restoring body 3 on the side of the base 1 can be represented by L=x sin(n/2−θ)=x cos θ in terms of θ and by (a−b+c+d)sin α in terms of α. The following equation (1) is obtained from the above:

L=x cos θ=(a−b+c+d)sin α Eq. (1).

Assuming that the gravity acting on the object OB, the movable body 2, the restoring body 3, the second shaft rod 42 and the second sliding bearings 52 is exerted around the pivot axis A2 of the movable body 2 on the side of the restoring body 3 with a magnitude of “G”, the force P1 acting to increase the displacement of the movable body 2 is expressed by P1=G cos θ. As is generally known, the “G” can be found by calculating a moment. If the restoring spring has a elastic modulus, e.g., a spring constant of “k”, the force P2 acting to return the movable body 2 is expressed by P2=k(b+d)sin α where the “b+d” denotes the displacement of the restoring spring 33 in the displaced position. The condition for balancing the forces P1 and P2 is that P1 is equal to P2. Thus, the following equation (2) can be obtained from this condition:

G cos θ=k(b+d)sin α Eq. (2).

The formula cos θ=sin α(a−b+c+d)/x is derived from eq. (1) and can be substituted into eq. (2) to eliminate sin α, whereby the following eq. (3) can be obtained:

G(a−b+c+d)=xk(b+d) Eq. (3).

If eq. (3) is established, the force P1 acting to increase the displacement of the movable body 2 is balanced with the force P2 acting to return the movable body 2 toward the home position, thereby stabilizing the position of the movable body 2. Here, the additional deformation amount of the restoring spring 33 “d” in the displaced position with respect to the home position depends on the displacement of the movable body 2 away from the home position and is a parameter indicative of the position of the movable body 2 relative to the base 1. Accordingly, in designing the movable arm of this embodiment, the condition that needs to be met in order to balance the forces P1 and P2 regardless of the position of the movable body 2 can be found by solving eq. (3) as an identity equation for “d”.

The condition thus obtained is that G=xk and further that 2b=a+c. If the spring constant k of the restoring spring 33 and the dimension of each part are properly selected to satisfy the condition, the forces P1 and P2 are balanced regardless of the position of the movable body 2, thereby stabilizing the position of the movable body 2. In other words, in the movable arm satisfying the above condition, the position of the object OB can be maintained even after removing an operating power irrespective of the manner of rotating of the movable body 2 relative to the base 1, which means that there is no need to continuously apply the force to maintain the position of the object OB.

The inventors of the present invention have found that, in case of the object OB weighing approximately 150 g, a movable arm, which is 400 mm in the length of the movable body 2, 10 mm in the distance between the first shaft insertion hole 12a and the third shaft insertion hole 13a, 2 N/mm in the spring constant, 90 mm in the free length “a” of the restoring spring 33 and 45 mm in the compression amount of the restoring spring 33 in the home position, ensures that the force P1 acting to increase the displacement of the movable body 2 is 1.2 kg and the force P2 acting to return the movable body 2 is 1.1 kg in the position illustrated in FIG. 4C, thus allowing the forces P1 and P2 to be substantially balanced with each other regardless of the position of the movable body 2.

In accordance with the configuration described above, the force P1 acting to increase the displacement of the movable body 2 is balanced with the force P2 acting to return the movable body 2, regardless of the location of the movable body 2 between the position illustrated in FIG. 4A and the position depicted in FIG. 4C. Moreover, independently of the frictional force, the movable body 2 is maintained in a desired position by the elastic force of the restoring body 3, i.e., the spring force of the restoring spring 33. This helps to eliminate or reduce the influence of wear, making it possible for the movable arm to exhibit durability for greater period of life span than that of the case where the position of the movable body 2 is maintained by the frictional force.

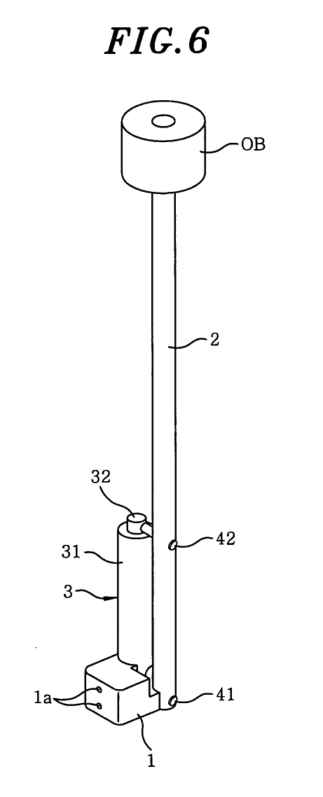

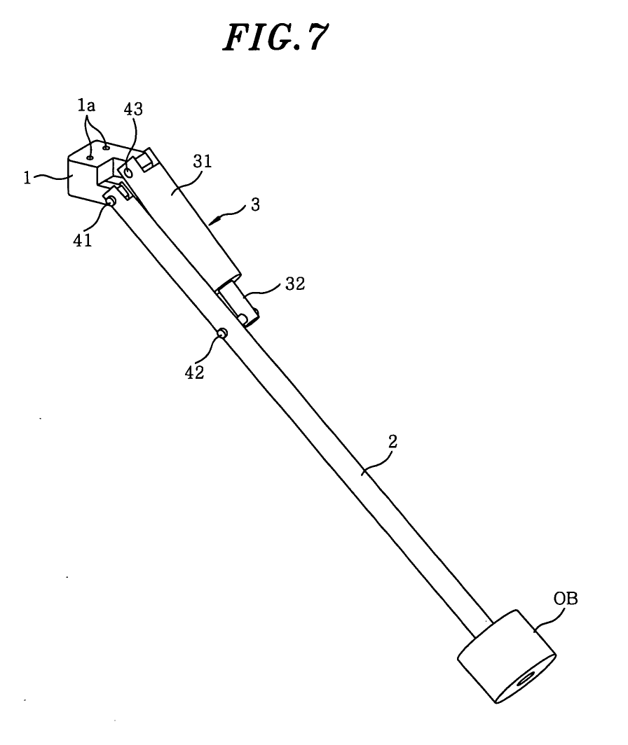

Further, the shape of the base 1 or the restoring body 3 is not limited to the one employed in this embodiment but may have a shape shown in FIG. 6 or FIG. 7. Movable arms of the modified embodiments illustrated in FIGS. 6 and 7 are structurally the same except for the location of screw holes 1a. Although a movable body 2 is provided on one side of a restoring body 3 and the movable body 2 and the base side member 31 of the restoring body 3 are of a cylindrical shape in the modified embodiments, the essential structures employed in the modified embodiments are identical to that of the embodiment shown in FIG. 1. More specifically, the movable body 2 is pivotally attached to the base 1 by means of a first shaft rod 41 inserted into first shaft insertion holes (not shown) respectively formed through the movable body 2 and the base 1.

The restoring body 3 includes a base side member 31 of a hollow cylinder shape, one end of which is pivotally attached to the base 1 by a third shaft rod 43; a movable body side member 32 of a cylindrical shape inserted into the base side member 31 for sliding movement in the axial direction of the base side member 31 and pivotally attached at one end thereof to the movable body 2 by a second shaft rod 42; and a restoring spring (not shown) interposed between the base side member 31 and the movable body side member 32 for exerting a spring force in such a direction as to reduce the dimension by which the movable body side member 32 protrudes from the base side member 31. In other words, the restoring body 3 as a whole has the elastic force acting in such a direction as to make the second shaft rod 42 and the third shaft rod 43 come closer.

Moreover, the third shaft rod 43 for pivotally attaching the restoring body 3 to the base 1 is arranged above the first shaft rod 41 for pivotally attaching the movable body 2 to the base 1. Thus, the elastic force of the restoring body 3 acts in such a direction as to erect the movable body 2 upright.

In the modified embodiments shown in FIGS. 6 and 7, the base 1 is provided with screw holes 1a into which screws (not shown) are tightened to threadedly mount the base 1 on a mounting surface. In other words, the base 1 may be fixedly secured to the mounting surface either by driving screws through a panel (not shown) constituting the mounting surface from the back side of the mounting surface and then threadedly fastening the screws into the screw holes 1a or by threadedly driving screws into the screw holes 1a through an attachment panel (not shown) and then securing the attachment panel to the mounting surface by using an additional fixture means such as screws. In the embodiment shown in FIG. 6, the screw holes 1a are opened at the side surface of the base 1 so that the base 1 can be attached to a wall surface (not shown) serving as the mounting surface. In the embodiment depicted in FIG. 7, the screw holes 1a are opened at the top surface of the base 1 so that the base 1 can be attached to a ceiling surface (not shown) serving as the mounting surface.

Moreover, unlike the embodiments described above, the restoring body 3 may be of a type exerting a elastic force in such a direction as to increase the overall length of the restoring body 3, i.e., in such a direction as to make the pivot axes A3 and A2 of the restoring body 3 on the side of the base 1 and the movable body 2 move away from each other. In this case, if the pivot axis A3 of the restoring body 3 is placed vertically below the pivot axis A1 of the movable body 2 in the opposite manner to the foregoing embodiments, the movable body 2 can be maintained upright in the home position.

What is claimed is:

1. A movable arm comprising:
a base mounted on a mounting surface;
a movable body for supporting an object, the movable body being pivotally attached to the base to rotate to change a position of the object with respect to the base; and
a restoring body for biasing the movable body in a direction to return the movable body to a home position with respect to the base, the restoring body being coupled to the movable body at a first coupling location spaced apart from a pivot axis of the movable body and to the base at a second coupling location spaced apart from the pivot axis of the movable body, the restoring body exerting a elastic force in a direction to make the first and second coupling location move closer to or away from each other,
wherein a elastic modulus of the restoring body, a deformation amount of the restoring body in the home position and dimensions related to the base, the movable body and the restoring body are determined to allow that
when the base is mounted on the mounting surface such that the second coupling location of the restoring body to the base and the pivot axis of the movable body lie on a common vertical plane and a center of gravity of the movable body and the object as a whole is placed above the pivot axis of the movable body while the movable body is in the home position,
a force exerted by a gravity to increase displacement of the movable body away from the home position is balanced with a force exerted by the restoring body to return the movable body to the home position, regardless of a position of the movable body with respect to the base, at least between the home position and a position in which the pivot axis of the movable body and the center of gravity of the movable body and the object as a whole lie side by side in a horizontal direction.

2. The movable arm of claim 1, further comprising a sliding body being interposed between the base and the movable body, the sliding body made of a material having a smaller friction coefficient than the base and the movable body.

3. A method of designing the movable arm of claim 1, comprising the step of solving an identity equation for a parameter indicative of the position of the movable body with respect to the base to determine the elastic modulus of the restoring body, the deformation amount of the restoring body in the home position and the dimensions related to the base, the movable body and the restoring body.
